(19) United States
(12) Patent Application Publication
(10) Pub. No.: US 2015/0247803 A1
(43) Pub. Date: Sep. 3, 2015

(54) Tunable Resonances from Conductively Coupled Plasmonic Nanorods

(71) Applicants: Jake Fontana, Alexandria, VA (US); Banahalli R. Ratna, Alexandria, VA (US)

(72) Inventors: Jake Fontana, Alexandria, VA (US); Banahalli R. Ratna, Alexandria, VA (US)

(73) Assignee: The Government of the United States of America, as represented by the Secretary of the Navy, Washington, DC (US)

(21) Appl. No.: 14/632,011

(22) Filed: Feb. 26, 2015

Related U.S. Application Data
(60) Provisional application No. 61/946,465, filed on Feb. 28, 2014.

(51) Int. Cl. G01N 21/65

(52) U.S. Cl. CPC G01N 21/658; Y10S 977/81; Y10S 977/811; B82Y 20/00

(57) ABSTRACT

A plasmonic nanostructure includes two plasmonic nanorods spaced apart by a gap and interconnected by a conductive junction spanning the gap, and mimics a longer nanostructure. This provides an ability to tune a structure in wavelengths that would be difficult to otherwise achieve.

### BACKGROUND

Synthesis of high aspect ratio (high-AR) nanoparticles, i.e., those that are significantly longer than wide, has proven difficult. This limits availability of such nanostructures that resonate at desired wavelengths. A need exists to surmount this problem.

### BRIEF SUMMARY

In a first embodiment, a sub-wavelength plasmonic nanostructure includes two plasmonic nanorods spaced apart by a gap and interconnected by a conductive junction spanning the gap.

A further embodiment, a method of using a plasmonic nanostructure includes providing a plasmonic nanostructure according to the first embodiment, introducing the plasmonic nanostructure to a cell, tissue, or organism, and then subjecting the cell, tissue, or organism to imaging and/or photothermal therapy.

In another embodiment, a method of tuning a sub-wavelength plasmonic nanostructure includes identifying a need for a nanostructure with a resonant wavelength of x; and providing a plasmonic nanostructure according to the first embodiment, having a resonant wavelength of x or greater, wherein x lies in the infrared spectrum.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1A shows a model of a Au nanorod (NR) dimer consisting of two hemispherically capped cylinders forming the Au NRs and interconnected by a Au cylinder. In a mathematical model, the structure was probed with linearly polarized light along the long axis of the dimer. FIG. 1B shows the calculated absorbance spectra for two Au NRs (D=10 nm, L=30 nm) separated by a gap, g=1 nm, and interconnected by a Au cylinder as a function of cylinder diameter, d.

FIG. 2 shows the calculated bonding dimer plasmon(BDP) and charge transfer plasmon (CTP) absorbance peaks as a function of the Au NR aspect ratio (g=d=1 nm, D=10 nm), and the longitudinal surface plasmon (LSP) absorbance peak for a single Au NR.

FIGS. 3A and 3B show CTP absorbance peak wavelength intensity map as a function of aspect ratio, g (FIG. 3A) and d (FIG. 3B). The contour lines are spaced in 0.5 μm intervals, D=10 nm for both plots and g=1 nm for (FIG. 3A) and d=1 nm for (FIG. 3B).

FIG. 4 shows calculated CTP absorbance peak wavelength as a function of the junction material: Ag, Au, Pt, Ti, and Si (g=d=1 nm, D=10 nm, L=30 nm).

FIGS. 5A through 5C show experimental results demonstrating the feasibility of the technique described herein.

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used in this specification and the appended claims, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

As used herein, the term “nanoparticle” refers to a particle having a largest dimension of at least about one nanometer and no greater than about 300 nanometers.

As used herein, the term “nanorod” refers to a rod-shaped nanoparticle having an aspect ratio greater than one.

### Overview

Described herein is a new class of anisotropic plasmonic nanostructure, based on charge transfer plasmons, to modulate the effective depolarization factor of the nanostructures enabling the resonant wavelength of the structure to be tuned. In embodiments, the plasmonic nanostructure may be tuned over the entire range of infrared wavelengths, and in particular embodiments over the range from 1 μm to 10 μm. These assemblies may be used to mimic more complex or hard to build structures, potentially leading to completely new metamaterial technologies.

Consider the case of two plasmonic nanoparticles approaching one another, forming a dimer. The plasmonic oscillations along the long axis of the dimer give rise to a bonding dimer plasmon (BDP) from the dipolar mode of each individual nanorod. If a conductive junction is placed between the nanoparticles, charge then flows between the nanoparticles giving rise to a new longer wavelength charge transfer plasmon (CTP) mode involving the entire dimer structure. The charge transfer mechanism can be based on a physical bridged connection via tunneling, such as direct or through-bond.

The fundamental mechanism enabling the unique optical properties of most plasmonic nanostructures is polarization. The Drude model describes the polarization, P̅, of such plasmonic materials remarkably well (see ref. 11): P̅=(ω_{P}²|( N̅ᵢⱼω_{P}²−ω²−iβω))ε₀Ē where the electric susceptibility is Xᵢⱼ=ω_{P}²|(Nᵢⱼω_{P}²−ω²−iβω),ω is the frequency, ω_{P} is the plasma frequency, β is the dampening constant, ε₀ is the permittivity of free space, and E is the applied electric field. The depolarization factor, N̅ᵢⱼ, in the diagonal frame, has three components, one for each principal axis of the nanoparticle (see ref. 11) For simplicity, X and N notation will be used to represent X̅ᵢⱼ and N̅ᵢⱼ throughout.

The imaginary part of the electric susceptibility is X″=(βω_{P}²ω)|((Nω_{P}²−ω²)+βω²).

The frequency where the susceptibility is maximum, and hence the absorbance, only depends on two parameters, ω₀=\sqrt{N}ω_{P}. The plasma frequency is material dependent and is proportional to the free charge density (see refs. 10 and 12). For example, gold has one of the highest free charge densities, on the order of 10²² cm⁻³, placing its resonant wavelength at λ₀≈140 nm (see refs. 13 and 14). Conversely, the depolarization factor depends on the geometry of the nanoparticle. For Au nanospheres all three of the principal components of the depolarization factor are equal to ⅓ yielding λ₀≈500 nm. If the nanosphere is elongated along one axis making an ellipsoid, N decreases along the long axis, shifting λ₀ to longer wavelengths. Ideally N would decrease indefinitely making λ₀ infinitely tunable. However, experimentally it is very difficult to synthesis high-AR NRs (ref. 15) leading to a small N thus limiting the tunable range of λ₀. Typically commercially available plasmonic Au NRs have ARs (length/diameter) less than 20, or λ₀≈2 μm (ref. 16). If N could be artificially modulated then λ₀ could potentially be tuned to the wavelength of choice, regardless of ω_{P}.

### Exemplary Configurations

The sub-wavelength plasmonic nanostructure includes two nanoparticles (e.g. spheres, rods, cubes, pyramids, etc.) interconnected by a conductive junction(s). Preferably, the nanoparticles are nanorods. In a particular embodiment, nanorods are spaced apart by a gap and interconnected by a conductive junction spanning the gap. In some embodiments, the nanostructure includes more than two interconnected nanorods.

The nanorods (about 5 nm to 300 nm in length) and the conductive junction (about 0.5 nm to 20 nm in size) may have unique or redundant dimensions for each principle axis. Exemplary nanorods have diameters of about 0.25 nm to about 50 nm and lengths of about 1 nm to about 300 nm. Exemplary nanorod aspect ratios are at least 1 and can be about 1.5 or greater, up to about 40. In embodiments, the nanorods are round or faceted cylinders, having flat ends, or ends that are pointed or rounded.

The plasmonic nanorods may include one or more of Ag, Au, Al, Ru, Pt, Ir, Rh, Pd, Ta, Ti, Cu, Mo, Ni, W, Co, Fe, Si, Sb, Ge, Bi, ZnO, SnO, In₂O₃, SiC, and GaAs. In embodiments, nanorods have a core/shell structure including a non-conducting core and a conducting shell.

The junction linking the plasmonic nanoparticles may be composed of organic or inorganic materials, or combination thereof.

Inorganic conductive junction material may include one or more of Ag, Au, Al, Ru, Pt, Ir, Rh, Pd, Ta, Ti, Cu, Mo, Ni, W, Co, Fe, Si, Sb, Ge, Bi, ZnO, SnO, In₂O₃, SiC, and GaAs.

Organic junction(s) such as conjugated molecules either covalently, electrostatic or hydrogen bound in between the nanoparticles forming the conductive junction may be composed singularly or in a plurality, but are not limited to oligo(phenylene ethynylene)dithiol (OPE), oligo(phenylene vinylene)dithiol (OPV), rhodamine, 4-(Dicyanomethylene)-2-methyl-6-(4-dimethylaminostyryl)-4H-pyran (DCM), rotaxane, perchlorate, perylene, DNA, and RNA.

The bridging molecules/junction may be coated with metallic or semi-conducting shells.

The nanoparticles may be bridged by thermodynamically driven forces (i.e. Ostwald ripening) forming the conductive junction. The structures may be assembled/fabricated via a top-down process, bottom-up process, or combination thereof.

By controlling the materials and geometry of the nanojunction the effective depolarization factor of the nanostructure can be controlled, thus tuning the resonance of the nanostructure, for example in the infrared range, or particularly between 1-10 μm. If the nanoparticles are nanorods, then the absorption shift is proportional to the nanorod aspect ratio (width/diameter), mimicking nanorods with an order of magnitude larger dimensions.

### Prophetic Example: Gold Nanorod Dimer Simulations

Numerical models demonstrated that an exemplary embodiment of these structures using gold nanorod dimers connected end-to-end by thin conductive junctions can have absorption peak resonances equivalent to single nanorods nearly an order of magnitude larger, a surprising and unexpected result. The absorbance peak sensitively depends on the resistance of the junction, capable of theoretically tuning the peak over approximately one decade from 1 μm to 10 μm. This straightforward paradigm opens up the question of whether CTP nanostructures could be used, via tuning an ‘effective’ depolarization factor, to mimic more complex or hard to build plasmonic nanostructures. Described here is a high-AR NR analog but other structures for example split-ring resonators may be assembled to overlap the spectral regions of negative permittivity and permeability.

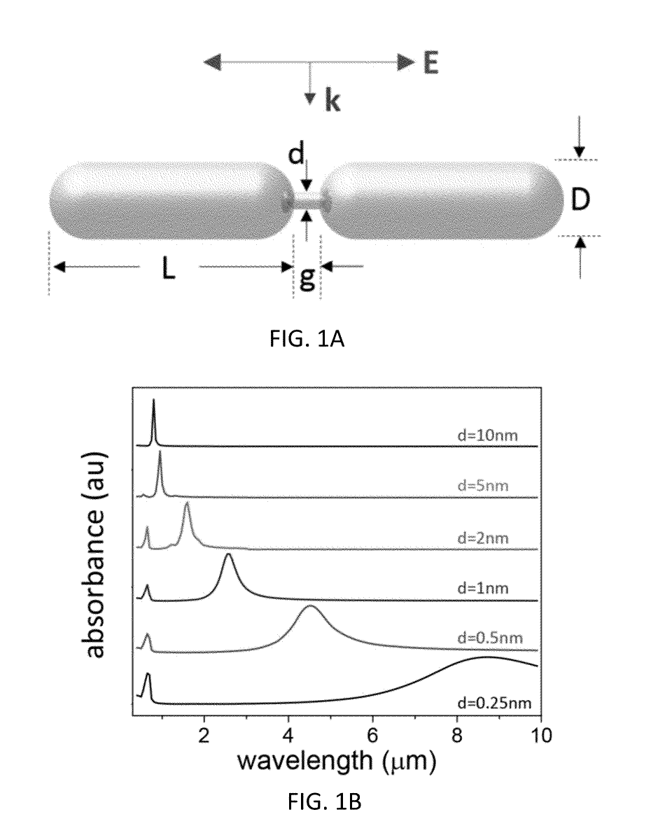

To probe the concept of artificially modulating N, the optical responses from Au NR dimers connected by thin metallic junctions were modeled using three-dimensional finite-element simulations (COMSOL Multiphysics 4.3a). The dimers were modeled as depicted in FIG. 1A. The dimer consists of two hemispherically capped cylinders forming the Au NRs with length L and diameter D, separated by a gap, g, connected by a Au cylinder of diameter d and suspended in a vacuum. D was set to 10 nm for all simulations. The junction was modeled using a Au connection (see refs. 9 and 19) unless otherwise stated. The refractive index of the materials from 0.4 μm to 10 μm were interpolated from literature (ref. 20). The structure was probed with light parallel to the long axis of the dimer. The absorbance was calculated directly from the S₂₁ coefficient retrieved from the simulations.

The normalized absorbance spectra as a function of d are presented in FIG. 1B for the dimer structure shown in FIG. 1A. For the case where D=d=10 nm, the dimer behaves as a single continuous Au NR with a longitudinal surface plasmon (LSP) absorbance peak emerging at 0.8 μm (dark blue). As d decreases to 5 nm (light green), two absorbance peaks emerge at 0.55 μm and 0.95 μm, corresponding to the BDP and CTP peaks, respectively. As d continues to decrease, the 0.95 μm CTP peak dramatically red-shifts, nearly one decade, to 8.74 μm when d=0.25 nm. As d decreases, the entire gap, composed of the connecting junction and surrounding vacuum, becomes more capacitive, broadening and eventually quenching the CTP peak (see refs. 2 and 9).

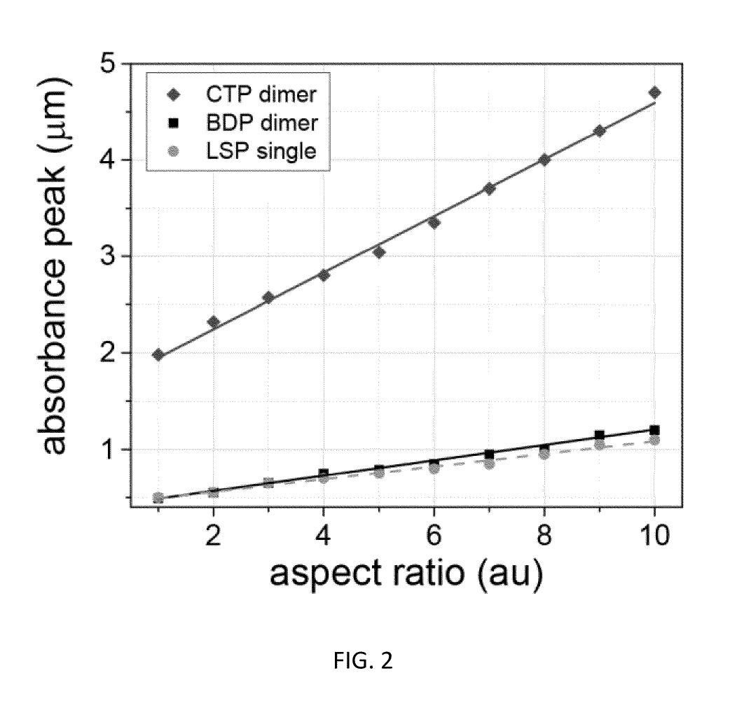

In FIG. 2, the absorbance peak wavelength for the BDP and CTP modes are plotted as a function of Au NR AR, where g and d are both set at 1 nm. As expected and demonstrated by others (ref. 21), the BDP absorbance peak, i.e. the individual NR dipole mode, shifts approximately linearly with the aspect ratio (black). The LSP absorbance peak from a single Au NR is also plotted (gray) for comparison and is slightly blue-shifted relative to the BDP dimer mode.

It was found that the CTP absorbance peak, i.e. the mode resulting from the entire dimer structure, also shifts linearly with the AR (red). The NR dimer behaves as if it was a single NR with an AR approximately an order of magnitude larger. To illustrate this point, if the absorbance peak shift from the single NR LSP mode is linearly extrapolated from FIG. 2, an aspect ratio of about 25 (AR≅25) is needed to have the same absorbance peak wavelength as a dimer composed of just two 10 nm diameter nanospheres, AR=1. For both the single NR and the dimer, is constant since they are both composed of the same material, Au, and if λ₀ only depends on λ_{P} and N, the large wavelength shift between the structures must be attributed to a changing N.

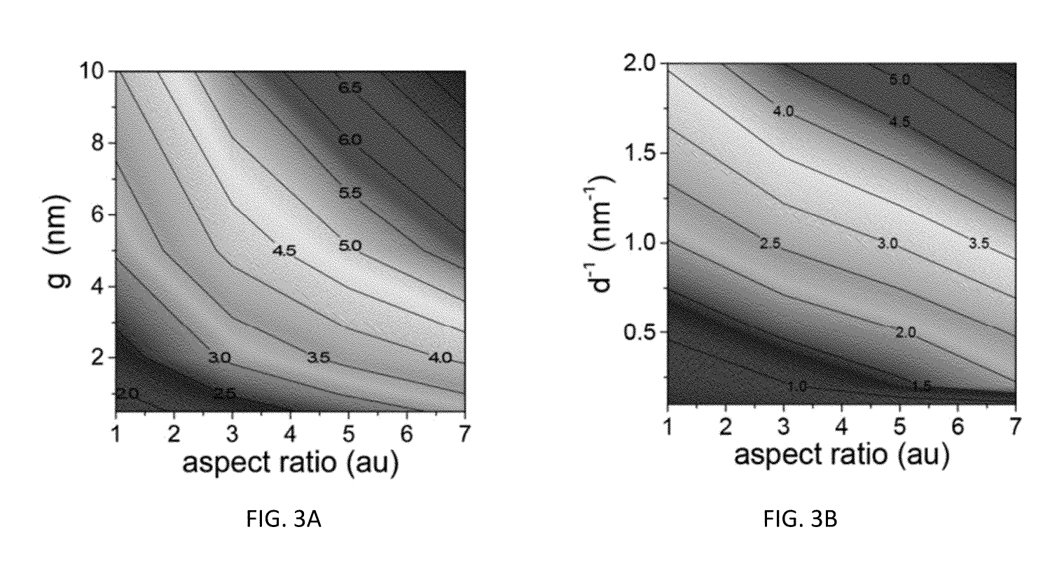

FIGS. 3A and 3B show the CTP absorbance peak as a function of AR, d and g. The peak shifts approximately proportional to both the AR and g, FIG. 3A, and also proportional to ˜d⁻¹, FIG. 3(b), for the majority of the parameter space probed. As the AR and g become larger or d smaller the absorbance peak shift red-shifts. FIGS. 3A and 3B also demonstrate the tunability from the AR parameter in determining the absorbance peak wavelength. For example from FIG. 3A if AR=1 and g=5 nm then λ₀≈3 μm. Yet if the AR is increased to 7, g decreases by an order of magnitude to 0.5 nm with the same absorbance peak wavelength. Similarly for FIG. 3B if AR=1 and d=0.6 nm yields the same peak wavelength as AR=7 and d=1.3 nm.

If two NRs of dissimilar length (e.g., 20 nm and 30 nm) are connected with a Au junction (g=d=1 nm), the CTP absorbance peak (λ₀=2.45 μm) is less than a dimer consisting of a similar pair of longer length NRs (30 nm;λ₀=2.55 μm), but greater than a dimer consisting of a similar pair of shorter length NRs (20 nm;λ₀≈2.30 μm). The shape of the CTP peak remains relatively symmetric about λ₀ even if the NRs are of dissimilar length.

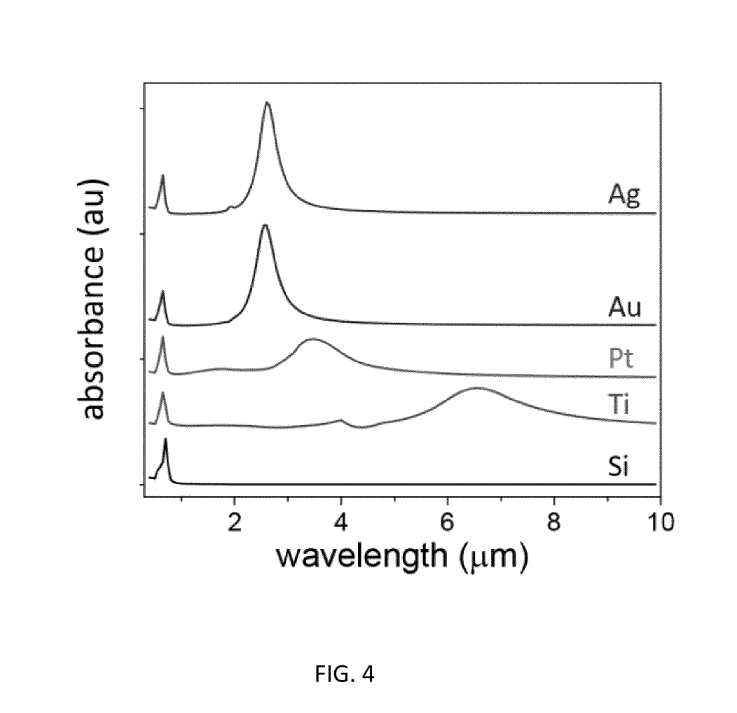

The CTP absorbance spectra for a NR dimer bridged by different materials Ag, Au, Pt, Ti and Si, for a fixed junction geometry (g=d=1 nm), are shown in FIG. 4. The magnitude of the CTP peak decreases and red-shifts as the resistivity, p, of the junction material increases (ref. 20). For the case of Si, where p is relatively large only the absorbance peak from the BDP mode exists since a local field persists across the gap between the NRs, allowing for significant capacitive coupling. As p decreases going from Si to Ag, the local field is expelled from the junction, reducing the capacitive coupling, enabling a sufficient quantity of charge to transfer between NRs in one optical cycle and allowing for the emergence of the CTP mode (ref. 2). The CTP mode is largest in magnitude when the resistivity is small such as the case for Ag. The small peak for Ti at 4 μm is from a band transition (ref. 20).

Thus, the CTP absorbance peak shift is proportional to the AR and pg/d. By increasing p, g or decreasing d the flow of charge between NRs is constrained, modulating N, resulting in the absorbance peak shifting to longer wavelengths providing a general strategy to tune the resonances of plasmonic nanostructures.

### Working Example: Gold Nanorod Dimer Experiments

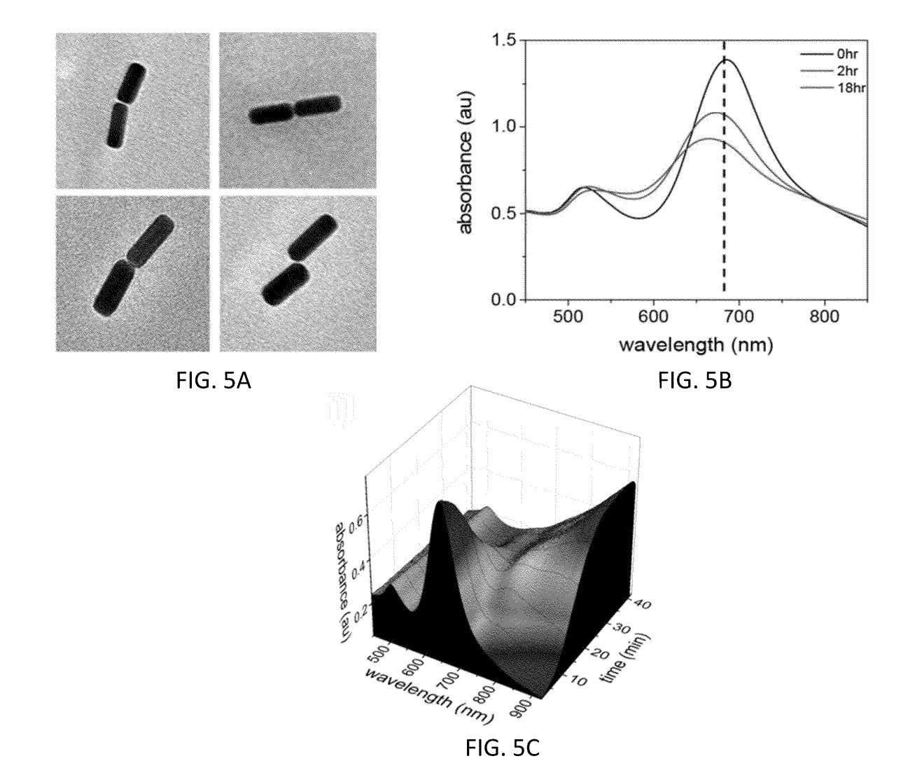

FIGS. 5A through 5C show experimental results demonstrating the feasibility of this technique. The dimers are gold nanorods (diameter=22 nm, length=68 nm; purchased from Nanorods, Inc.) self-assembled with a molecular bridge, disodium chromoglycate, similar to the end-to-end assembly method described in refs. 22 and 23, except the nanorods were coated with a 1% polyacrylic acid (Mol. Wt. 250 k). The representative transmission electron microscopy images in FIG. 5A are from the aqueous self-assembly reaction after two hours, yielding predominately gold nanorod dimers. FIG. 5B shows the in situ absorbance spectra for the self-assembly reaction. Initially the longitudinal surface plasmon (LSP) resonance from the individual nanorods peaks at 685 nm. As the reaction takes place, the LSP peak wavelength blue-shifts to 663 nm and decreases in magnitude from 1.39 to 0.93 as a function of time. An isobestic point is also observed at 795 nm. As shown by others (ref. 2), if two nanoparticles are in close proximity, the fields from the individual particles capacitively couple red-shifting the BDP peak, relative to the isolated particle. If a conductive junction is established between the particles the capacitance decreases and the BDP wavelength blue-shifts. This is directly observed in FIG. 5B. The isobestic point and the decreasing peak magnitude are indicative of a second absorbance peak emerging beyond 900 nm. Since the reaction is aqueous based absorbance measurement beyond 1000 nm is difficult due to the absorption of water. These results provide evidence for the emergence of the CTP peak and the feasibility of the technique described herein.

Additionally, the in situ absorbance evolution of covalently bound nanorod dimers is seen in FIG. 5C under conditions of using 1-hexanedithiol in a acetonitrile and water suspension (see ref. 24). An isobestic point is observed at 730 nm and a second (dimer) peak emerges initially at 780 nm (t=20 min.) and continues to red-shift as additional nanorods concatenate onto the dimer.

### Advantages and Applications

Sub-wavelength plasmonic nanoparticles linked though conductive junctions to modulate the resonance of the structure over nearly one decade from 1 μm to 10 μm. It is expected that an even greater range, encompassing the entire infrared spectrum (700 nm to 1 mm) could be possible. These CTP nanostructures could be used to mimic more complex or hard to build plasmonic nanostructures (e.g., high aspect ratio nanorods, split-ring resonators).

The ability to broadly tune the electric and magnetic resonances can in turn control the optical (e.g., absorption, reflection, transmission, scattering spectra), chemical (e.g., catalysis, oxidation state) and electronic (e.g., conduction, heat capacity) properties of the composite structures and subsequent materials.

These nanostructures may lead to smaller, lighter materials for controlling electromagnetic fields, e.g.,. transformational optics, or biological/chemical detection, e.g., surface-enhanced (UV/VIS/IR) Raman spectroscopy.

The nanostructures may be used for in vivo or in vitro medical applications. As noted in ref. 25, suitable applications can include imaging and photothermal therapy.

### Concluding Remarks

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

### REFERENCES

[1] Perez-Gonzalez, O., J. Aizpurua, and N. Zabala, Optical transport and sensing in plexcitonic nanocavities. Optics Express, 2013. 21(13): p. 15847-15858.

[2] Perez-Gonzalez, O., N. Zabala, A. G. Borisov, N. J. Halas, P. Nordlander, and J. Aizpurua, Optical Spectroscopy of Conductive Junctions in Plasmonic Cavities. Nano Letters, 2010. 10(8): p. 3090-3095.

[3] Danckwerts, M. and L. Novotny, Optical Frequency Mixing at Coupled Gold Nanoparticles. Physical Review Letters, 2007. 98(2): p. 026104.

[4] Atay, T., J.-H. Song, and A. V. Nurmikko, Strongly Interacting Plasmon Nanoparticle Pairs: From Dipole—Dipole Interaction to Conductively Coupled Regime. Nano Letters, 2004. 4(9): p. 1627-1631.

[5] Lassiter, J. B., J. Aizpurua, L. I. Hernandez, D. W. Brandl, I. Romero, S. Lal, J. H. Hafner, P. Nordlander, and N. J. Halas, Close Encounters between Two Nanoshells. Nano Letters, 2008. 8(4): p. 1212-1218.

[6] Duan, H., A. I. Fernandez-Dominguez, M. Bosman, S. A. Maier, and J. K. Yang, Nanoplasmonics: classical down to the nanometer scale. Nano Lett, 2012. 12(3): p. 1683-9.

[7] Aizpurua, J., G. W. Bryant, L. J. Richter, F. J. G. de Abajo, B. K. Kelley, and T. Mallouk, Optical properties of coupled metallic nanorods for field-enhanced spectroscopy. Physical Review B, 2005. 71(23).

[8] Alber, I., W. Sigle, F. Demming-Janssen, R. Neumann, C. Trautmann, P. A. van Aken, and M. E. Toimil-Molares, Multipole Surface Plasmon Resonances in Conductively Coupled Metal Nanowire Dimers. Acs Nano, 2012. 6(11): p. 9711-9717.

[9] Schnell, M., A. Garcia-Etxarri, A. J. Huber, K. Crozier, J. Aizpurua, and R. Hillenbrand, Controlling the near-field oscillations of loaded plasmonic nanoantennas. Nature Photonics, 2009. 3(5): p. 287-291.

[10] Large, N., M. Abb, J. Aizpurua, and O. L. Muskens, Photoconductively Loaded Plasmonic Nanoantenna as Building Block for Ultracompact Optical Switches. Nano Letters, 2010. 10(5): p. 1741-1746.

[11] Bohren, C. F. and D. R. Huffman, Absorption and Scattering of Light by Small Particles. 1983: Wiley-VCH.

[12] Boltasseva, A. and H. A. Atwater, Low-Loss Plasmonic Metamaterials. Science, 2011. 331(6015): p. 290-291.

[13] Ordal, M. A., R. J. Bell, J. R. W. Alexander, L. L. Long, and M. R. Querry, Optical properties of fourteen metals in the infrared and far infrared: Al, Co, Cu, Au, Fe, Pb, Mo, Ni, Pd, Pt, Ag, Ti, V, and W. Applied Optics, 1985. 24(24): p. 4493-4499.

[14] Blaber, M. G., M. D. Arnold, and M. J. Ford, Search for the Ideal Plasmonic Nanoshell: The Effects of Surface Scattering and Alternatives to Gold and Silver. The Journal of Physical Chemistry C, 2009. 113(8): p. 3041-3045.

[15] Khanal, B. P. and E. R. Zubarev, Purification of High Aspect Ratio Gold Nanorods: Complete Removal of Platelets. Journal of the American Chemical Society, 2008. 130(38): p. 12634-12635.

[16] Busbee, B. D., S. O. Obare, and C. J. Murphy, An improved synthesis of high-aspect-ratio gold nanorods. Advanced Materials, 2003. 15(5): p. 414-+.

[17] Shelby, R. A., D. R. Smith, and S. Schultz, Experimental verification of a negative index of refraction. Science, 2001. 292(5514): p. 77-79.

[18] Klar, T. A., A. V. Kildishev, V. P. Drachev, and V. M. Shalaev, Negative-index metamaterials: Going optical. Ieee Journal of Selected Topics in Quantum Electronics, 2006. 12(6): p. 1106-1115.

[19] Scholl, J. A., A. Garcia-Etxarri, A. L. Koh, and J. A. Dionne, Observation of Quantum Tunneling between Two Plasmonic Nanoparticles. Nano Letters, 2012. 13(2): p. 564-569.

[20] Palik, E. D., Handbook of Optical Constants of Solids. 1985, Boston: Academic Press.

[21] Link, S., M. B. Mohamed, and M. A. El-Sayed, Simulation of the optical absorption spectra of gold nanorods as a function of their aspect ratio and the effect of the medium dielectric constant. Journal of Physical Chemistry B, 1999. 103(16): p. 3073-3077.

[22] Park, H. S., A. Agarwal, N. A. Kotov, and O. D. Lavrentovich, Controllable Side-by-Side and End-to-End Assembly of Au Nanorods by Lyotropic Chromonic Materials. Langmuir, 2008. 24(24): p. 13833-13837.

[23] Lavrentovich, O. D. and H. S. Park, nanoparticle composition, a device and a method thereof. 2010, US Patent Publication No. 2010/0044650

[24] Pramod, P. and K. G. Thomas, Plasmon Coupling in Dimers of Au Nanorods. Advanced Materials, 2008. 20(22): p. 4300-4305.

[25] Huang X, El-Sayed I H, Qian W, El-Sayed MA. Cancer Cell Imaging and Photothermal Therapy in the Near-Infrared Region by Using Gold Nanorods. Journal of the American Chemical Society 2006 2006/02/01; 128(6): 2115-2120.

What is claimed is:

1. A sub-wavelength plasmonic nanostructure comprising two plasmonic nanorods spaced apart by a gap and interconnected by a conductive junction spanning the gap.

2. The nanostructure of claim 1, wherein said nanorods each independently have a length of about 5 nm to 300 nm.

3. The nanostructure of claim 1, wherein said nanorods each independently comprise an inorganic material selected from the group consisting of Ag, Au, Al, Ru, Pt, Ir, Rh, Pd, Ta, Ti, Cu, Mo, Ni, W, Co, Fe, Si, Sb, Ge, Bi, ZnO, SnO, In₂O₃, SiC, and GaAs.

4. The nanostructure of claim 1, wherein at least one of said nanorods comprises a coating of a metallic or semi-conducting shell.

5. The nanostructure of claim 1, wherein said conductive junction has a size of less than 20 nm.

6. The nanostructure of claim 1, wherein the conductive junction comprises one or more of:
(a) an inorganic material selected from the group consisting of Ag, Au, Al, Ru, Pt, Ir, Rh, Pd, Ta, Ti, Cu, Mo, Ni, W, Co, Fe, Si, Sb, Ge, Bi, ZnO, SnO, In₂O₃, SiC, and GaAs; and/or
(b) an organic material selected from the group consisting of oligo(phenylene ethynylene)dithiol (OPE), oligo(phenylene vinylene)dithiol (OPV), rhodamine, 4-(Dicyanomethylene)-2-methyl-6-(4-dimethylaminostyryl)-4H-pyran (DCM), rotaxane, perchlorate, perylene, DNA, and RNA.

7. The nanostructure of claim 1, wherein said conductive junction comprises a coating of a metallic or semi-conducting shell.

8. The nanostructure of claim 1, wherein a charge transfer mechanism is operable between said nanorods, the charge transfer mechanism being based on a physical linkage and/or tunneling through said conductive junction.

9. The nanostructure of claim 1, having a resonance in the infrared range.

10. The nanostructure of claim 9, having a resonant wavelength of between about 1 μm and 10 μm.

11. The nanostructure of claim 1, wherein an effective depolarization factor along a length of said nanostructure is at least ten times smaller than that of an isolated nanorod having the same dimensions and composition as one of said nanorods.

12. A method of using a plasmonic nanostructure, comprising:
providing a sub-wavelength plasmonic nanostructure comprising two plasmonic nanorods spaced apart by a gap and interconnected by a conductive junction spanning the gap;
introducing the plasmonic nanostructure to a cell, tissue, or organism; and
then subjecting the cell, tissue, or organism to imaging and/or photothermal therapy.

13. A method of tuning a sub-wavelength plasmonic nanostructure, the method comprising:
(a) identifying a need for a nanostructure with a resonant wavelength of x; and
(b) providing a plasmonic nanostructure comprising two plasmonic nanorods spaced apart by a gap and interconnected by a conductive junction spanning the gap, the nanostructure having a resonant wavelength of x or greater,
wherein x lies in the infrared spectrum.

14. The method of claim 13, wherein x is between about 1 μm and about 10 μm.

15. The method of claim 13, wherein x is between about 1 μm and 10 μm.

16. The method of claim 13, wherein both the electric and/or magnetic susceptibility of the nanostructure are controlled by selecting dimensions of said nanorods and/or said conductive junction.

17. The method of claim 13, wherein an effective depolarization factor along a length of said nanostructure is at least ten times smaller than that of an isolated nanorod having the same dimensions and composition as one of said nanorods.
